(19) United States
(12) Patent Application Publication
(10) Pub. No.: US 2019/0302520 A1
(43) Pub. Date: Oct. 3, 2019

(54) COLOR FILTER SUBSTRATE AND LIQUID CRYSTAL DISPLAY DEVICE

(71) Applicant: SHARP KABUSHIKI KAISHA, Sakai City (JP)

(72) Inventors: MASAHIRO HASEGAWA, Sakai City (JP); AKIRA SAKAI, Sakai City (JP); TAKAKO KOIDE, Sakai City (JP); YUICHI KAWAHIRA, Sakai City (JP); KOJI MURATA, Sakai City (JP); KIYOSHI MINOURA, Sakai City (JP)

(21) Appl. No.: 16/368,530

(22) Filed: Mar. 28, 2019

Related U.S. Application Data
(60) Provisional application No. 62/649,715, filed on Mar. 29, 2018.

(51) Int. Cl. G02F 1/1335; G02F 1/13363; G02F 1/1368

(52) U.S. Cl. CPC G02F 1/133514; G02F 1/133528; G02F 1/13363; G02F 2001/133519; G02F 1/133512; G02F 2001/133638; G02F 1/1368

(57) ABSTRACT

The present invention provides a color filter substrate in which a step on the surface of the base of a retardation layer and light leakage from a black matrix are prevented and that can prevent parallax color mixture when used in a liquid crystal display device, and a liquid crystal display device including the color filter substrate. The color filter substrate includes a substrate, a metal black matrix disposed on the substrate and provided with an opening, a color layer covering the opening and made of coloring photosensitive resin, and a retardation layer disposed on the color layer.

### CROSS-REFERENCE TO RELATED APPLICATIONS

The present application claims priority under 35 U.S.C. § 119 to U.S. Provisional Patent Application No. 62/649,715 filed on Mar. 29, 2018, the contents of which are incorporated herein by reference in their entirety.

### BACKGROUND OF THE INVENTION

### Field of the Invention

The present invention relates to a color filter substrate and a liquid crystal display device. The present invention particularly relates to a color filter substrate including a retardation layer, and a liquid crystal display device including a color filter substrate including a retardation layer.

### Description of Related Art

A liquid crystal display device includes a liquid crystal composition for display. In a typical display scheme thereof, the transmission amount of light is controlled by applying voltage to a liquid crystal composition encapsulated between a color filter substrate including a color filter and an active matrix substrate including a switching element such as a thin-film transistor and changing the alignment state of liquid crystal molecules in the liquid crystal composition in accordance with the applied voltage. Such a liquid crystal display device with characteristics of small thickness, lightweight, and low electric power consumption is widely used in various fields.

A color filter substrate used in a liquid crystal display device includes, for example, a color layer made of red photosensitive resin, green photosensitive resin, and blue photosensitive resin, and a black matrix disposed at a boundary part between adjacent sub-pixels. As a technology related to the black matrix, for example, JP 2008-009018 A discloses a liquid crystal display element including, between a first polarizing plate and a second polarizing plate, an STN-type liquid crystal cell including a metal black matrix, and a twist optical compensation layer for solving display coloring that would otherwise occur at the STN-type liquid crystal cell.

JP 2001-100010 A discloses that a metal black matrix used for a color filter substrate of a liquid crystal panel and formed of a deposition material not substantially containing Cr on a transparent substrate is a Ag alloy black matrix made of a ternary alloy containing Ag as a primary component.

### BRIEF SUMMARY OF THE INVENTION

When a liquid crystal display device is used in bright environment such as outdoor, it is difficult to visually recognize a display image due to strong screen reflection. This is, for example, largely because of interface reflection at a black matrix included in a color filter substrate, and an indium tin oxide (ITO) thin film for preventing alignment disorder of a liquid crystal layer due to electrical charging. The interface reflection can be prevented by employing a circularly polarizing plate in which an out-cell retardation layer as a λ/4 plate is combined with a polarizer on the visual recognition side. When the out-cell retardation layer is provided to the liquid crystal display device, a λ/4 plate (in-cell retardation layer) having a slow axis orthogonal to the out-cell retardation layer is provided between the liquid crystal layer and a color layer in some cases. With this configuration, it is possible to achieve a state in which the out-cell retardation layer and the in-cell retardation layer do not substantially exist at transmission display as the out-cell retardation layer and the in-cell retardation layer function to cancel the phase difference therebetween, and thus it is possible to obtain an optical property equivalent to that of a typical liquid crystal display device while achieving low reflection.

FIG. 10 is a microscope picture illustrating exemplary light leakage at black display in a liquid crystal display device according to a comparative example including an out-cell retardation layer and an in-cell retardation layer. The present inventors had various kinds of discussions on the liquid crystal display device according to the comparative example including the out-cell retardation layer and the in-cell retardation layer. As a result, it was found that, in the liquid crystal display device according to the comparative example, light leakage as illustrated in FIG. 10 increases at an end part of a sub-pixel 100R (region surrounded by dotted lines in FIG. 10) at black display, which reduces the contrast of the liquid crystal display device in some cases.

As a result of discussions on the cause by the present inventors, it was found that the contrast reduction is potentially caused by the large film thickness of a resin black matrix in a color filter substrate included in the liquid crystal display device.

FIG. 11A is a schematic cross-sectional view of a color filter substrate according to the comparative example, illustrating a state after an overcoat layer is provided on a color layer. FIG. 11B is a schematic cross-sectional view of the color filter substrate according to the comparative example, illustrating a state after an in-cell retardation layer is provided on the overcoat layer. The following describes, with reference to FIGS. 11A and 11B, the cause of contrast reduction due to light leakage at black display in the liquid crystal display device according to the comparative example including the out-cell retardation layer and the in-cell retardation layer.

This color filter substrate 10R according to the comparative example is produced as follows. First, a resin black matrix 12R provided with an opening 121R corresponding to each sub-pixel is formed on a glass substrate 11R. Subsequently, to prevent light leakage, a color layer 13R made of red, green, and blue coloring photosensitive resins is formed on the opening 121R, overlapping with the resin black matrix 12R. Since the color layer 13R overlaps with the resin black matrix 12R, the color layer 13R has a raised shape extending from a central part of a sub-pixel 100R to an end part thereof overlapping with the resin black matrix 12R as illustrated in FIG. 11A, and a step (irregularity) occurs near the end part of the sub-pixel 100R. As the film thickness of the resin black matrix 12R is larger, the film thickness of the color layer 13R more steeply changes in the vicinity of the resin black matrix 12R, and the step on the surface of the color layer 13R is larger. When an overcoat layer 14R is stacked on the color layer 13R in such a state to flatten the step, the shape of the overcoat layer 14R somehow follows the step of the color layer 13R and thus it not completely flat, and a result, a step occurs the surface of the overcoat layer 14R near the end part of the sub-pixel 100R.

When an in-cell retardation layer 15R is provided on the overcoat layer 14R having the step on the surface, the film thickness of the in-cell retardation layer 15R differs between parts of the sub-pixel 100R as illustrated in FIG. 11B, more specifically, the film thickness of the retardation layer 15R changes near the end part of the sub-pixel 100R, which results in unevenness in the phase difference of the in-cell retardation layer 15R. In a liquid crystal display device in which the color filter substrate 10R including the in-cell retardation layer 15R suffering such phase difference unevenness is combined with an out-cell retardation layer having a uniform phase difference in the surface, it is thought that the phase difference of the out-cell retardation layer cannot be sufficiently canceled by the phase difference of the in-cell retardation layer 15R, and thus light leakage occurs from the opening 121R of the resin black matrix 12R (in particular, the vicinity of the end part of the sub-pixel 100R where the film thickness of the retardation layer 15R is likely to change) at black display, which leads to the contrast reduction. From this, it was found that, to prevent reduction of the contrast of the liquid crystal display device, it is important to reduce change in the film thickness of the in-cell retardation layer by preventing a step on the surface of the base of the in-cell retardation layer at the opening of the black matrix, thereby preventing light leakage from the opening of the black matrix at black display.

This can be achieved by reducing the film thickness of the resin black matrix, but with this method, light-shielding at the resin black matrix is insufficient, and light leakage occurs from the resin black matrix, which results in reduction of the contrast of the liquid crystal display device in some cases.

In another method, the film thickness of the overcoat layer provided on the color layer is increased, but with this method, light in an oblique direction cannot be shielded by the resin black matrix due to the thick overcoat layer. As a result, the light from in the oblique direction transmits through an adjacent sub-pixel of another color, and color mixture potentially occurs when observation is performed in the oblique direction. The color mixture that occurs when observation is performed in the oblique direction is also referred to as parallax color mixture.

JP 2008-009018 A and JP 2001-100010 A do not disclose a color filter substrate in which a step on the surface of the base of a retardation layer and light leakage from the black matrix are prevented and that can prevent parallax color mixture when used in a liquid crystal display device.

The present invention has been made in view of such a current state of the art and aims to provide a color filter substrate in which a step on the surface of the base of a retardation layer and light leakage from a black matrix are prevented and that can prevent parallax color mixture when used in a liquid crystal display device, and a liquid crystal display device in which a step on the surface of the base of a retardation layer and light leakage from a black matrix are prevented and that can prevent parallax color mixture.

The present inventors have focused on a metal black matrix as a result of discussions on a color filter substrate in which a step on the surface of the base of a retardation layer and light leakage from a black matrix are prevented and that can prevent parallax color mixture when used in a liquid crystal display device, and a liquid crystal display device including the color filter substrate. The metal black matrix has a high light-shielding property and can provide sufficient light-shielding property with a small film thickness, and thus it was found that, in a color filter substrate including a metal black matrix provided with an opening, a color layer covering the opening and made of coloring photosensitive resin, and a retardation layer disposed on the color layer, it is possible to reduce a step on the surface of the color layer and thus reduce a step on the surface of the base of the retardation layer, and it is also possible to reduce light leakage from the metal black matrix. Since it is possible to prevent a step on the surface of the color layer, it was found that another layer having a large thickness does not need to be provided to flatten the surface of the base of the retardation layer, and it is possible to prevent occurrence of parallax color mixture when the color filter substrate is used in a liquid crystal display device. Thereby, the present inventors have arrived at the solution to the above problem, completing the present invention.

Specifically, one aspect of the present invention may be a color filter substrate including: a substrate; a metal black matrix disposed on the substrate and provided with an opening; a color layer covering the opening and made of coloring photosensitive resin; and a retardation layer disposed on the color layer.

The color filter substrate may further include an overcoat layer between the color layer and the retardation layer.

The metal black matrix may have a film thickness of 0.25 μm or smaller.

Another aspect of the present invention may be a liquid crystal display device including, sequentially from a viewer side: a first polarizing plate; a retardation layer having a phase difference of λ/4; a color filter substrate; a liquid crystal layer having anisotropy of dielectric constant; an active matrix substrate including a switching element; and a second polarizing plate. The color filter substrate may include: a substrate; a metal black matrix disposed on the substrate and provided with an opening; a color layer covering the opening and made of coloring photosensitive resin; and a retardation layer disposed on the color layer.

The color filter substrate may further include an overcoat layer between the color layer and the retardation layer.

The metal black matrix may have a film thickness of 0.25 μm or smaller.

The retardation layer included in the color filter substrate may have a phase difference of λ/4.

In the liquid crystal display device, a display mode may be an IPS mode, an FFS mode, or a VA mode.

The present invention can provide a color filter substrate in which a step on the surface of a base of a retardation layer and light leakage from a black matrix are reduced and that can prevent parallax color mixture when used in a liquid crystal display device.

In addition, the present invention can provide a liquid crystal display device in which a step on the surface of a base of a retardation layer and light leakage from a black matrix are reduced and that can prevent parallax color mixture.

### BRIEF DESCRIPTION OF THE DRAWINGS

FIG. 1A is a schematic cross-sectional view of a color filter substrate according to Embodiment 1;

FIG. 1B is a schematic plan view of the color filter substrate according to Embodiment 1;

FIG. 2 is a schematic cross-sectional view of a color filter substrate according to Embodiment 2;

FIG. 3 is a schematic cross-sectional view of a liquid crystal display device according to Embodiment 3;

FIG. 4 is a schematic cross-sectional view of a liquid crystal display device according to Embodiment 4;

FIG. 5 is a schematic cross-sectional view of a color filter substrate according to Example 1;

FIG. 6 is a schematic cross-sectional view of a color filter substrate according to Example 2;

FIG. 7 is a schematic cross-sectional view of a color filter substrate according to Example 3;

FIG. 8 is a schematic cross-sectional view of a liquid crystal display device according to Example 4;

FIG. 9 is a schematic cross-sectional view of a liquid crystal display device according to Example 6;

FIG. 10 is a microscope picture illustrating exemplary light leakage at black display in a liquid crystal display device according to a comparative example including an out-cell retardation layer and an in-cell retardation layer;

FIG. 11A is a schematic cross-sectional view of a color filter substrate according to the comparative example, illustrating a state after an overcoat layer is provided on a color layer;

FIG. 11B is a schematic cross-sectional view of the color filter substrate according to the comparative example, illustrating a state after an in-cell retardation layer is provided on the overcoat layer;

FIG. 12 is a schematic cross-sectional view of a color filter substrate according to Comparative Example 1;

FIG. 13 is a schematic cross-sectional view of a color filter substrate according to Comparative Example 2; and

FIG. 14 is a schematic cross-sectional view of a color filter substrate according to Comparative Example 3.

### DETAILED DESCRIPTION OF THE INVENTION

Embodiments of the present invention will be described below. The present invention is not limited to the following embodiments, and it is possible to appropriately modify the design within the scope of satisfying the constitution of the present invention. In the following description, the same reference numerals are used for the same parts or parts having similar functions in different drawings, and the repetitive description thereof is omitted. Configurations of the embodiment may appropriately be combined or modified without departing from the spirit of the present invention.

### Embodiment 1

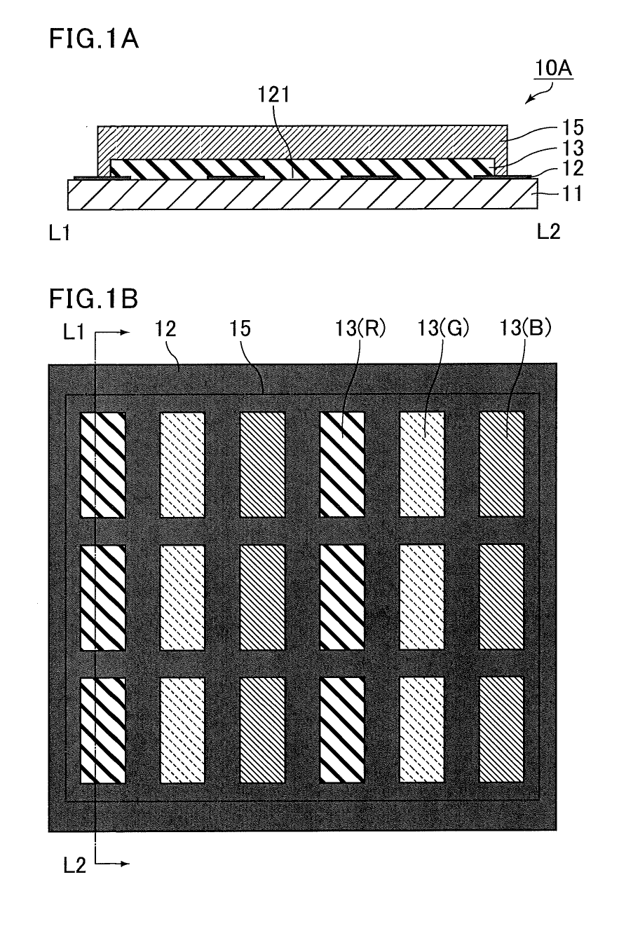

FIG. 1A is a schematic cross-sectional view of a color filter substrate according to Embodiment 1. FIG. 1B is a schematic plan view of the color filter substrate according to Embodiment 1. FIG. 1A illustrates a section taken along line L1-L2 in FIG. 1B. As illustrated in FIGS. 1A and 1B, a color filter substrate 10A according to the present embodiment includes: a glass substrate 11 as a substrate; a metal black matrix 12 disposed on the glass substrate 11 and provided with multiple openings 121; a color layer 13 covering each opening 121 and made of coloring photosensitive resin; and a retardation layer 15 (also referred to as in-cell retardation layer 15) disposed on the color layer 13. In the present specification, an opening of a black matrix (metal black matrix or resin black matrix) is also simply referred to as “opening”.

The metal black matrix 12 has a light-shielding property higher than that of a typical resin black matrix, and thus can have a reduced film thickness necessary for obtaining a desired light-shielding property as compared to that of a resin black matrix. Specifically, for example, with a film thickness approximately equal to 1/10 to ⅕ of that of a typical resin black matrix, the metal black matrix 12 can achieve an optical density (OD) value equivalent to that of the typical resin black matrix. Thus, when the color layer 13 is formed of coloring photosensitive resin on the metal black matrix 12 to cover each opening 121, it is possible to reduce light leakage from the metal black matrix 12 and reduce a step on the surface of the color layer 13 as the base of the retardation layer 15.

Since the flatness of the color layer 13 can be improved by using the metal black matrix 12 as described above, another layer having a large thickness does not need to be provided on the color layer 13 to improve the flatness of the color layer 13. Thus, it is possible to prevent parallax color mixture due to a thick layer when the color filter substrate 10A is used in a liquid crystal display device.

The above-described substrate is a transparent base material (transparent substrate). Examples of the substrate include a plastic substrate in addition to the glass substrate 11.

The metal black matrix 12 is a black matrix formed of a metal film. The metal black matrix 12 is a light-shielding member for preventing color mixture, disposed in a lattice shape corresponding to the boundary between adjacent sub-pixels in the liquid crystal display device, and provided with the openings 121 corresponding to the respective sub-pixels. The metal black matrix 12, which is formed of a metal film, has a high light-shielding property with a small film thickness. In the present specification, a sub-pixel means a single color (typically, primary color) region included in a pixel included in a color display image.

The metal black matrix 12 preferably has a film thickness of 0.25 μm or smaller. With this configuration, it is possible to improve the flatness of the color layer 13 as the base of the retardation layer 15 and further reduce a step on the surface of the color layer 13. The metal black matrix 12 more preferably has a film thickness of 0.5 to 2.0 μm, further more preferably has a film thickness of 1.0 to 2.0 μm.

The metal black matrix 12 preferably has an OD value of three or larger, more preferably an OD value of 3.2 or larger. With this configuration, it is possible to further reduce light leakage from the metal black matrix 12. The upper limit of the OD value of the metal black matrix 12 is not particularly limited.

Metal contained in the metal black matrix 12 is not particularly limited, and may be, for example, Ag, Au, Pd, Pt, Ru, Rh, Re, Cu, Ti, Zr, or Zn. The metal black matrix 12 preferably contains a ternary alloy containing, Ag as a primary component, any one of 1 AU, Pd, Pt, Ru, Rh, and Re, and any one of 1 Cu, Ti, Zr, and Zn, more preferably contains Ag, Pd, and Cu.

The metal black matrix 12 is formed by, for example, providing a metal thin film on the glass substrate 11 by sputtering, and then performing patterning by photolithography.

The color layer 13 covers each opening 121 and overlaps with the metal black matrix 12 around the opening 121. The color layer 13 is formed of coloring photosensitive resin. The color layer 13 includes a red resin layer (red color layer R), a green resin layer (green color layer G), and a blue resin layer (blue color layer B) each provided in a stripe shape and repeatedly provided in the transverse direction of the stripe (lateral direction illustrated in FIG. 1B). The resin layer of each color is partitioned by the metal black matrix 12 in a lattice shape. As a result, the red, green, or blue resin layer is disposed at each sub-pixel of the liquid crystal display device, and the three red, green, and blue sub-pixels are provided in stripe shapes at each pixel of the liquid crystal display device. In the present embodiment, the three colors are disposed in stripe shapes, but the three colors may be disposed in mosaic or delta, four colors such as red, green, blue, and yellow may be arrayed in stripe shapes or square shapes, or five or more colors may be arrayed.

The film thickness of the color layer 13 is preferably 1.5 to 3.5 μm at the openings 121, more preferably 2.0 to 3.0 μm.

The coloring photosensitive resin is photosensitive resin containing colorant. The colorant is, for example, at least one kind of pigment, at least one kind of dye, or their composite. The pigment and the dye may be those typically used in the field of color filter. The photosensitive resin is polymer, the property of which changes through light irradiation, and may be those typically used in the field of color filter such as a photoresist.

The color layer 13 is formed, for example, by photolithography involving application and deposition of coloring photosensitive resin on the openings 121 and the metal black matrix 12, and exposure, image development, and the like. The coloring photosensitive resin may be of a negative type or a positive.

The retardation layer 15 has a function of changing the state of incident polarization by providing a phase difference between two polarization components orthogonal to each other by using a birefringent material or the like.

The retardation layer 15 preferably has a phase difference of λ/4 when the liquid crystal display device is produced by using the color filter substrate 10A. However, the in-plane phase difference of a retardation layer (in-cell retardation layer) normally decreases through thermal treatment at manufacturing. Accordingly, the phase difference of a retardation layer included in a color filter substrate typically decreases through incorporation of the color filter substrate into the liquid crystal display device. This is because the process of assembling the liquid crystal display device includes a thermal treatment process such as the process of firing an alignment film. Thus, the retardation layer 15 included in the color filter substrate 10A before incorporation into the liquid crystal display device preferably has a phase difference larger than λ/4, preferably has a phase difference of 150 to 210 nm.

In the present specification, unless otherwise stated, “phase difference” means an in-plane phase difference, and the phase difference or the in-plane phase difference means the in-plane phase difference of a layer (film) at a wavelength of 550 nm. The in-plane phase difference is given by Re=(nx−ny)×d, where d (nm) represents the thickness of the layer (film). In the formula, “nx” represents a refractive index in a direction (in other words, a slow axial direction) in which the in-plane refractive index is at maximum, “ny” represents a refractive index in a direction orthogonal to the in-plane slow axis, and “nz” represents a refractive index in the thickness direction. Unless otherwise stated, each refractive index is a value for light having a wavelength of 550 nm. The phase difference of λ/4 is an in-plane phase difference of ¼ wavelength (precisely, 137.5 nm) for light having a wavelength of at least 550 nm, and needs to be an in-plane phase difference of 110 to 170 nm.

The material of the retardation layer 15 in the present embodiment is not particularly limited, and for example, the retardation layer 15 may be formed of liquid crystalline polymer containing a photoreactive group (hereinafter also simply referred to as “liquid crystalline polymer”). The retardation layer 15 may be a layer in which a liquid crystalline polymer is aligned on an alignment film for the retardation layer 15.

Examples of the liquid crystalline polymer include polymer that includes a side chain having a structure including: a mesogenic group such as a biphenyl group, a terphenyl group, a naphthalene group, a phenylbenzoate group, an azobenzene group, or a derivative thereof frequently used as a mesogenic component of liquid crystalline polymer; and a photoreactive group such as a cinnamoyl group, a chalcone group, a cinnamylidene group, a β-(2-phenyl) acryloyl group, a cinnamic acid group, or a derivative thereof, and that includes a main chain having a structure of acrylate, methacrylate, maleimide, N-phenyl maleimide, siloxane, or the like.

The liquid crystalline polymer may be a homopolymer composed of a single repeating unit or may be a copolymer composed of two or more repeating units having different side chain structures. The above copolymer includes any of an alternating type, a random type, a graft type and the like. In addition, in the copolymer, the side chain related to at least one repeating unit is a side chain having a structure having both the mesogenic group and the photoreactive group, but the side chain related to the other repeating unit may not have a mesogenic group or the photoreactive group.

The film thickness of the retardation layer 15 is not particularly limited, but may be adjusted as appropriate in accordance with the phase difference and the in-plane refractive index difference (Δn) of the liquid crystalline polymer, and is, for example, 0.5 to 2.0 μm.

The following describes an exemplary method of forming the retardation layer 15. The retardation layer 15 can be formed by using a retardation layer composition containing the above-described liquid crystalline polymer. The retardation layer composition may contain a component normally contained in a polymerizable composition causing polymerization by light and heat as appropriate in addition to the liquid crystalline polymer, solvent, photopolymerization initiator, surface-active agent, and the like.

The retardation layer 15 can be formed by, for example, forming, on the color layer 13, a photo-alignment film that exhibits an alignment characteristic through irradiation with polarized ultraviolet light and applying the above-described retardation layer composition on the photo-alignment film. The method of applying the retardation layer composition may be any of typically known methods in this field, and is, for example, a spin coating method, a bar coating method, a die coater method, a screen printing method, or a spray coater method. Right after the application of the retardation layer 15, the retardation layer 15 preferably has a phase difference of 150 to 210 nm as described above.

### Embodiment 2

In the present embodiment, description is mainly made on characteristics unique to the present embodiment, but not on any content duplicating those in the above-described embodiments. A color filter substrate according to Embodiment 2 is same as Embodiment 1 except that an overcoat layer is provided between the color layer 13 and the retardation layer 15 in Embodiment 1.

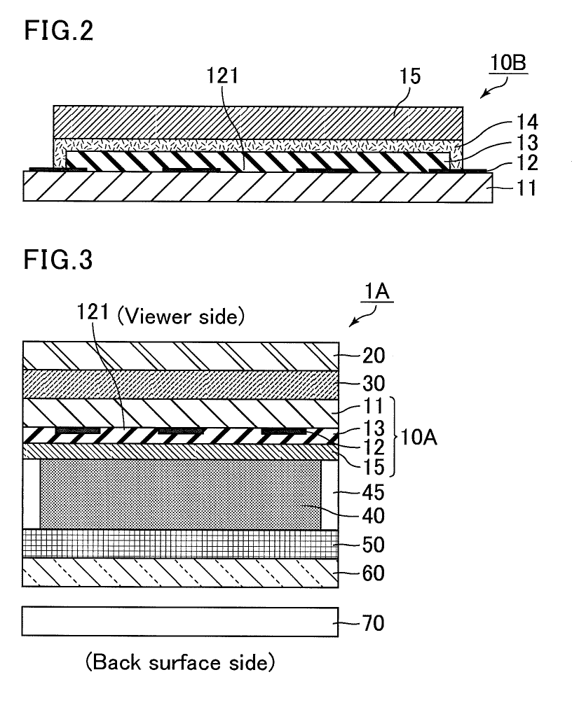

FIG. 2 is a schematic cross-sectional view of the color filter substrate according to Embodiment 2. A color filter substrate 10B according to the present embodiment includes: the glass substrate 11 as a substrate; the metal black matrix 12 disposed on the glass substrate 11 and provided with the openings 121; the color layer 13 covering the openings 121 and made of coloring photosensitive resin; an overcoat layer 14 disposed on the color layer 13; and the retardation layer 15 disposed on the overcoat layer 14.

In the present embodiment, similarly to Embodiment 1, it is possible to prevent a step on the surface of the color layer 13 by using the metal black matrix 12, and thus it is also possible to prevent a step on the surface of the overcoat layer 14 as the base of the retardation layer 15, which is disposed on the color layer 13. In addition, similarly to Embodiment 1 described above, it is possible to prevent light leakage from the metal black matrix 12.

In addition, since it is possible to prevent a step on the surface of the color layer 13 as described above, the film thickness of the overcoat layer 14 does not need to be increased to prevent a step on the surface of the overcoat layer 14. Thus, it is possible to prevent parallax color mixture due to the overcoat layer 14 when the color filter substrate 10B is used in a liquid crystal display device.

In addition, in the present embodiment, since the overcoat layer 14 is additionally provided between the color layer 13 and the retardation layer 15, it is possible to further reduce a step on the surface of the base of the retardation layer 15 as compared to Embodiment 1 described above.

The overcoat layer 14 is provided to cover the surface (upper surface and side surface) of the color layer 13. The overcoat layer 14 flattens the surface. The overcoat layer 14 is preferably made of transparent resin. The overcoat layer 14 is formed by, for example, applying light-curing resin on the color layer 13 and performing ultraviolet irradiation and firing.

In the present embodiment, since it is possible to prevent a step on the surface of the color layer 13 by using the metal black matrix 12, the film thickness of the overcoat layer 14 provided to flatten the surface does not need to be increased, but may be, for example, 0.8 to 1.6 μm (preferably 1.0 to 1.4 μm). Thus, in the present embodiment, the flattening effect by the overcoat layer 14 can be obtained while parallax color mixture is prevented.

### [Modification]

In each of the color filter substrates 10A and 10B in Embodiments 1 and 2 described above, a photo spacer (column-shaped spacer) may be provided on the retardation layer 15. As described above, the in-plane phase difference of a retardation layer (in-cell retardation layer) normally decreases through thermal treatment at manufacturing. Accordingly, the phase difference of the retardation layer included in the color filter substrate is typically smaller after the photo spacer is provided on the retardation layer than right after application of the retardation layer. Thus, when the photo spacer is provided on the color filter substrate 10A or 10B, the retardation layer 15 preferably has a phase difference of 140 to 190 nm. The photo spacer is formed by, for example, patterning a photosensitive resin film (photoresist) into a column-shaped structure by photolithography.

### Embodiment 3

In the present embodiment, description is mainly made on characteristics unique to the present embodiment, but not on any content duplicating those in the above-described embodiments. A liquid crystal display device according to Embodiment 3 is a liquid crystal display device produced by using the color filter substrate 10A according to Embodiment 1.

FIG. 3 is a schematic cross-sectional view of the liquid crystal display device according to Embodiment 3. A liquid crystal display device 1A according to the present embodiment includes, sequentially from a viewer side to a back surface side, a first polarizing plate 20, an out-cell retardation layer 30, the color filter substrate 10A, a liquid crystal layer 40, an active matrix substrate 50, a second polarizing plate 60, and a backlight 70. The color filter substrate 10A and the active matrix substrate 50 are bonded to each other by a seal 45.

The color filter substrate 10A includes, sequentially from the viewer side to the back surface side, the glass substrate 11, the metal black matrix 12 provided with the openings 121, the color layer 13, and the in-cell retardation layer 15.

The retardation layer 15 of the color filter substrate 10A included in the liquid crystal display device 1A according to Embodiment 3 normally has a phase difference smaller than that at completion of the color filter substrate 10A. More specifically, the retardation layer 15 preferably has a phase difference of λ/4. With this configuration, an optical property equivalent to that of a typical liquid crystal display device can be achieved while reflection of external light is prevented by the out-cell retardation layer 30 having a phase difference of λ/4 to be described later.

A photo spacer (not illustrated) is provided to the color filter substrate 10A to maintain a constant gap and form the liquid crystal layer 40 in the gap. An alignment film (not illustrated) is provided between the color filter substrate 10A and the liquid crystal layer 40, and another alignment film (not illustrated) is provided between the active matrix substrate 50 and the liquid crystal layer 40.

In the present embodiment, similarly to Embodiment 1 described above, it is possible to prevent a step on the surface of the color layer 13 by using the metal black matrix 12, and it is possible to prevent unevenness of the film thickness of the in-cell retardation layer 15 in each opening 121 of the black matrix 12. The out-cell retardation layer 30 can have a uniform phase difference in the substrate surface. Thus, it is possible to prevent change in the phase difference of the in-cell retardation layer 15 for the phase difference of the out-cell retardation layer 30 in each opening 121. As a result, it is possible to prevent light leakage from each opening 121 at black display due to the difference between the phase difference of, the out-cell retardation layer 30 and the phase difference of the in-cell retardation layer 15, thereby increasing the contrast of the liquid crystal display device 1A.

In the present embodiment, similarly to Embodiment 1 described above, it is possible to prevent light leakage from the metal black matrix 12, and thus it is possible to further improve the contrast of the liquid crystal display device 1A.

In addition, similarly to Embodiment 1 described above, another layer having a large thickness does not need to be provided to prevent a step on the surface of the color layer 13, and thus it is possible to prevent perspective color mixture due to a thick layer.

The active matrix substrate 50 includes a thin-film transistor (TFT) as a switching element, and has a structure in which a substrate (not illustrated), a counter electrode (not illustrated), an insulating film (not illustrated), and a pixel electrode (not illustrated) including an opening are stacked sequentially from the back surface side to the viewer side. In other words, the liquid crystal display device 1A according to the present embodiment is a liquid crystal display device of a fringe field switching (FFS) mode. In the present embodiment, the planar counter electrode is disposed on the back surface side, and the pixel electrode including an opening is disposed on the viewer side, but the positions of the counter electrode and the pixel electrode may be interchanged so that the pixel electrode planarly provided for each sub-pixel is disposed on the back surface side, and the counter electrode including an opening may be disposed on the viewer side.

The out-cell retardation layer 30 changes the state of incident polarization by providing a phase difference between two polarization components orthogonal to each other by using a birefringent material. The out-cell retardation layer 30 is preferably a retardation layer (λ/4 plate) that applies an in-plane phase difference of ¼ wavelength to light having a wavelength of at least 550 nm, and specifically, preferably applies an in-plane phase difference of 110 to 170 nm to light having a wavelength of at least 550 nm. When the out-cell retardation layer 30 functions as a λ/4 plate, the first polarizing plate 20 and the out-cell retardation layer 30 cooperatively function as a circularly polarizing plate. Accordingly, the internal reflection of the liquid crystal display device is reduced to achieve favorable black display with reduced reflection of external light.

In a liquid crystal display device not provided with an in-cell retardation layer but only provided with an out-cell retardation layer, black display cannot be performed in some cases, but this situation can be improved when the in-cell retardation layer 15 is provided together with the out-cell retardation layer 30 as in the liquid crystal display device 1A according to the present embodiment. It is preferable that the slow axis of the out-cell retardation layer 30 and the slow axis of the in-cell retardation layer 15 are orthogonal to each other, and the phase difference value of the out-cell retardation layer 30 and the phase difference value of the in-cell retardation layer 15 are equal to each other (including a case in which they are substantially equal to each other). Accordingly, the out-cell retardation layer 30 and the in-cell retardation layer 15 function to cancel the phase differences for light incident in the normal direction of the liquid crystal display device 1A, thereby achieving a state in which they optically do not substantially exist. In other words, a configuration optically equivalent to that of a conventional liquid crystal display device is achieved for light incident on the liquid crystal display device 1A from the backlight 70.

The out-cell retardation layer 30 may be a liquid crystalline polymer film used in the in-cell retardation layer 15, or may be a stretching processed polymer film, which is typically used in the field of liquid crystal display device. Examples of the material of the polymer film include cycloolefin polymer, polycarbonate, polysulfone, polyethersulfone, polyethylene terephthalate, polyethylene, polyvinyl alcohol, norbornene, triacetyl cellulose, and diacetyl cellulose, and cycloolefin polymer is preferable. A retardation layer formed of cycloolefin polymer has excellent durability, and suffers small phase difference change when exposed in high-temperature environment or high-temperature high-humidity environment for a long duration. Known cycloolefin polymer films include a “Zeonor film (registered trademark)” manufactured by Zeon Corporation, and an “ARTON (registered trademark) film” manufactured by JSR Corporation.

The liquid crystal layer 40 contains a liquid crystal composition, and the light transmission amount thereof is controlled by applying voltage to the liquid crystal layer 40 to change the alignment state of liquid crystal molecules in the liquid crystal composition in accordance with the applied voltage.

The liquid crystal molecules used in the present embodiment are bar liquid crystal molecules, and the anisotropy of dielectric constant (Δε), which is defined by an expression below, may have a positive value or a negative value for the liquid crystal molecule. The liquid crystal molecules having the positive anisotropy of dielectric constant are also referred to as positive liquid crystal, and the liquid crystal molecules having the negative anisotropy of dielectric constant are also referred to as negative liquid crystal. The long axial direction of the liquid crystal molecules is the direction of the slow axis. The liquid crystal molecules homogeneously align in a state (no-voltage application state) in which no voltage is applied, and the direction of the long axis of the liquid crystal molecules in the no-voltage application state is also referred to as an initial alignment direction of the liquid crystal molecules.

Δε=(dielectric constant in long axial direction)−(dielectric constant in short axial direction)

The alignment film has a function to control the alignment of the liquid crystal molecules in the liquid crystal layer 40, and the alignment of the liquid crystal molecules in the liquid crystal layer 40 is controlled mainly by the function of the alignment film when a voltage applied to the liquid crystal layer 40 is lower than a threshold voltage (including no voltage application). The alignment film is a layer provided with alignment treatment for controlling the alignment of the liquid crystal molecules, and may be a typical alignment film of, for example, polyimide in the field of liquid crystal display panel.

A viewing angle compensation film may be provided between the first polarizing plate 20 and the out-cell retardation layer 30 or between the active matrix substrate 50 and the second polarizing plate 60.

The viewing angle compensation film is a phase difference film for optical compensation, and may be made of liquid crystalline polymer, which is used for the in-cell retardation layer 15, or may be a commercially available film provided with secondary fabrication such as stretching processing and/or contract processing. Examples of commercially available polymer films made of cellulose resin include “Fujitac” manufactured by Fuji Photo Film Co., Ltd., and “KC8UX2M” manufactured by Konica Minolta Opto Co. Examples of polymer films made of norbornene resin include “Zeonor film” manufactured by Zeon Corporation, and “ARTON” manufactured by JSR Corporation.

In the present embodiment, description is exemplarily made with a liquid crystal display device of the FFS mode, but the liquid crystal drive mode of a liquid crystal display device is not particularly limited. Examples of liquid crystal drive modes other than the FFS mode include an in-plane switching (IPS) mode and a vertical alignment (VA) mode. In the IPS mode, a strip-shaped counter electrode and a strip-shaped pixel electrode are alternately provided to the active matrix substrate 50.

In the VA mode, one of a pixel electrode and a counter electrode is provided on the active matrix substrate 50, and the other electrode is provided on the color filter substrate 10A, and in the liquid crystal layer 40, the negative liquid crystal is aligned perpendicularly to the substrate surface in the no-voltage application state.

A liquid crystal cell of a super-twisted nematic (STN) mode is used in JP 2008-009018 A, and viewing angle characteristics of contrast and color are not desirable, but in the present embodiment, a wide viewing angle characteristic can be achieved by using the liquid crystal drive mode of the FFS mode, the IPS mode, or the VA mode.

Examples of the materials of the counter electrode and the pixel electrode include indium tin oxide (ITO) and indium zinc oxide (IZO). Examples of the material of the insulating film include an organic insulating film and a nitride film.

Similarly to the substrate included in the color filter substrate 10A, the substrate included in the active matrix substrate 50 is a transparent base material (transparent substrate), and for example, a glass substrate or a plastic substrate.

The first polarizing plate 20 and the second polarizing plate 60 are absorptive polarizers and have a crossed Nicols disposition relation in which their absorption axes are orthogonal to each other. The first polarizing plate 20 and the second polarizing plate 60 may be each, for example, a polarizer (absorptive polarizing plate) by causing an anisotropic material such as iodine complex (or dye) to dye and adsorb on a polyvinyl alcohol (PVA) film and then stretching and aligning the film.

The type of the backlight 70 is not limited, and an edge-lit type or direct-lit type backlight may be employed, for example. The type of a light source of the backlight 70 is not limited, but may be, for example, a light-emitting diode (LED) or a cold cathode fluorescent lamp (CCFL).

### Embodiment 4

In the present embodiment, description is mainly made on characteristics unique to the present embodiment, but not on any content duplicating those in the above-described embodiments. A liquid crystal display device according to Embodiment 4 is a liquid crystal display device produced by using the color filter substrate 10B according to Embodiment 2. In other words, the liquid crystal display device according to the present embodiment is same as the liquid crystal display device according to Embodiment 3 except that the liquid crystal display device is produced by using the color filter substrate 10B according to Embodiment 2.

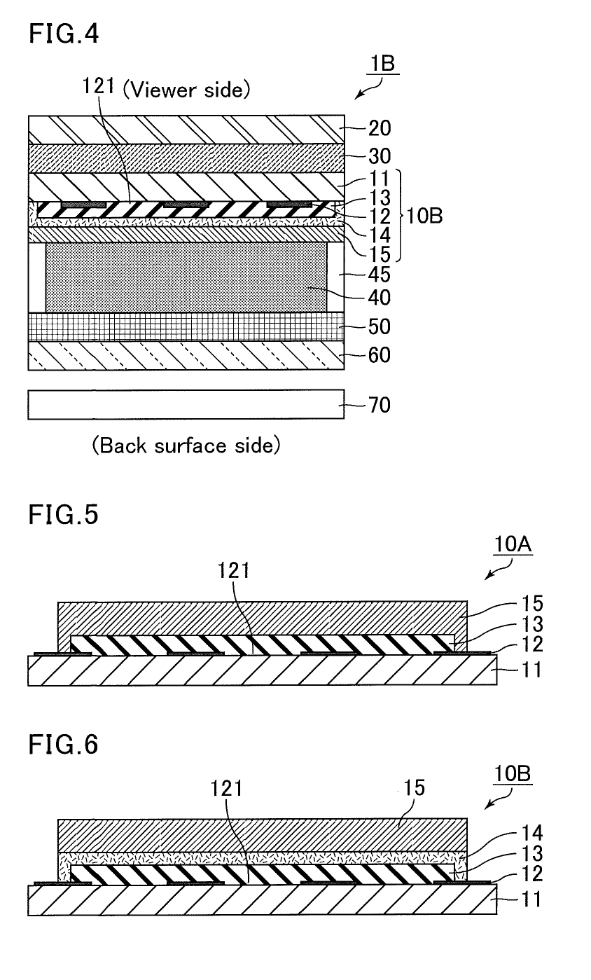

FIG. 4 is a schematic cross-sectional view of the liquid crystal display device according to Embodiment 4. A liquid crystal display device 1B according to the present embodiment includes, sequentially from the viewer side to the back surface side, the first polarizing plate 20, the out-cell retardation layer 30, the color filter substrate 10B, the liquid crystal layer 40, the active matrix substrate 50, the second polarizing plate 60, and the backlight 70. The color filter substrate 10B and the active matrix substrate 50 are bonded to each other by the seal 45.

The color filter substrate 10B includes, sequentially from the viewer side to the back surface side, the glass substrate 11, the metal black matrix 12 provided with the openings 121, the color layer 13, the overcoat layer 14, and the in-cell retardation layer 15.

The retardation layer 15 of the color filter substrate 10B included in the liquid crystal display device 1B according to Embodiment 4 normally has a phase difference smaller than that at completion of the color filter substrate 10B, and specifically, preferably has a phase difference of λ/4. With this configuration, an optical property equivalent to that of a typical liquid crystal display device can be achieved while reflection of external light is prevented by the out-cell retardation layer 30 having a phase difference of λ/4.

A photo spacer (not illustrated) is provided to the color filter substrate 10B to maintain a constant gap and form the liquid crystal layer 40 in the gap. An alignment film (not illustrated) is provided between the color filter substrate 10B and the liquid crystal layer 40, and another alignment film (not illustrated) is provided between the active matrix substrate 50 and the liquid crystal layer 40.

In the present embodiment, similarly to Embodiment 2 described above, it is possible to prevent a step on the surface of the color layer 13 by using the metal black matrix 12, and thus it is also possible to prevent a step on the surface of the overcoat layer 14 as the base of the retardation layer 15, which is disposed on the color layer 13. In addition, similarly to Embodiment 1 described above, it is possible to prevent light leakage from the metal black matrix 12.

In addition, since it is possible to prevent a step on the surface of the color layer 13 as described above, the film thickness of the overcoat layer 14 does not need to be increased to prevent a step on the surface of the overcoat layer 14. Thus, it is possible to prevent parallax color mixture due to the overcoat layer 14 in the liquid crystal display device 1B.

In addition, in the present embodiment, since the overcoat layer 14 is additionally provided between the color layer 13 and the retardation layer 15, it is possible to further reduce a step on the surface of the base of the retardation layer 15 as compared to Embodiment 3 described above.

Although the embodiments of the present invention have been described above, all the individual matters described can be applied to the whole of the present invention.

Hereinafter, the present invention will be described in more detail with reference to examples, comparative examples, and reference examples, but the present invention is not limited to only these examples.

### Example 1

FIG. 5 is a schematic cross-sectional view of color filter substrate according to Example 1. A metal thin film was formed by sputtering an alloy (Ag—Pd—Cu: APC) of silver, palladium, and copper on the glass substrate 11 as a substrate in an Ar atmosphere by sputtering to have a film thickness of 0.1 μm. Thereafter, patterning was performed by photolithography to produce the metal black matrix 12 provided with the openings 121.

Subsequently, red photoresist containing color matter such as pigment as red coloring photosensitive resin was applied, and subjected to preliminary firing followed by exposure, development, and main firing to cover the metal black matrix 12 to prevent light leakage, thereby forming a red resin layer (red color layer) at every three sub-pixels in a parallel direction (the lateral direction in FIG. 1B) of the substrate. Thereafter, a green resin layer (green color layer) and a blue resin layer (blue color layer) were formed by the same method to provide the color layer 13. At the openings 121 of the metal black matrix 12, the film thickness of the red color layer was 2.25 μm, the film thickness of the green color layer was 2.23 μm, and the film thickness of the blue color layer was 2.21 μm.

The color layer 13 was irradiated with polarization ultraviolet (also referred to as polarization UV) to apply a photo-alignment film having an alignment characteristic, and then subjected to preliminary firing, polarization UV irradiation, and main firing. In addition, reactive mesogen having a reactive group at an end of a liquid crystalline molecule was applied thereon, and the whole was irradiated with UV and fired to form the in-cell retardation layer 15. The formed in-cell retardation layer 15 had an in-plane phase difference value of 183 nm for a wavelength of 550 nm. The axis orientation (slow axis) of the in-cell retardation layer 15 was at 45° when the surface of the glass substrate 11 faced upward. In the present specification, the axis orientation when the surface of the glass substrate faces upward is the orientation of an axis when (it is assumed that) a liquid crystal display device is produced by using a color filter substrate and the color filter substrate is observed from the viewer side. The orientation is a direction with respect to a reference (0° direction) as the right-side direction in the horizontal direction in a plan view of the liquid crystal display device, and the positive orientation is defined to be in the anticlockwise direction from the reference, whereas the negative orientation is defined to be in the clockwise direction. The in-plane phase difference value of the in-cell retardation layer was measured by using a high-speed and high-precision Mueller matrix polarimeter AxoScan (manufactured by AXOMETRICS), and calculated from the average value of the phase difference for several sub-pixels.

Thereafter, photosensitive resin was applied on the entire surface of the in-cell retardation layer 15, and after preliminary firing, patterning was performed by photolithography to allow formation of a structure at a predetermined position and main firing was performed to form a photo spacer, thereby producing the color filter substrate 10A according to Example 1. At this stage, the in-cell retardation layer 15 had an in-plane phase difference value (average over in-plane nine points) of 158.0 nm for a wavelength of 550 nm.

### Example 2

FIG. 6 is a schematic cross-sectional view of color filter substrate according to Example 2. In the color filter substrate 10A according to Example 1, the color filter substrate 10B according to Example 2 was produced in the same manner as in Example 1 except that the overcoat layer 14 was provided between the color layer 13 and the in-cell retardation layer 15. Specifically, in the process of producing the color filter substrate 10A according to Example 1, after the color layer 13 made of the red resin layer, the green resin layer, and the blue resin layer was formed, a UV curing color filter overcoat (00) material was applied on the entire surface, irradiated with UV, and fired to flatten the surface of the color layer 13. The film thickness of the overcoat layer 14 was 1.3 μm.

The photo-alignment film having an alignment characteristic was applied through irradiation of the overcoat layer 14 with polarization UV, and preliminary firing, polarization UV irradiation, and main firing were performed. In addition, reactive mesogen having a reactive group at an end of a liquid crystalline molecule was applied thereon, and the whole was irradiated with UV and fired to form the in-cell retardation layer 15. The formed in-cell retardation layer 15 had an in-plane phase difference value of 183 nm for a wavelength of 550 nm. The axis direction (slow axis) of the in-cell retardation layer 15 was at 45° when the surface of the glass substrate faced upward.

Thereafter, photosensitive resin was applied on the entire surface of the in-cell retardation layer 15, and after preliminary fired, patterning was performed by photolithography to allow formation of a structure at a predetermined position and main firing was performed to form a photo spacer, thereby producing the color filter substrate 10B according to Example 2. At this stage, the in-cell retardation layer 15 had an in-plane phase difference value (average over in-plane nine points) of 157.4 nm for a wavelength of 550 nm.

### Example 3

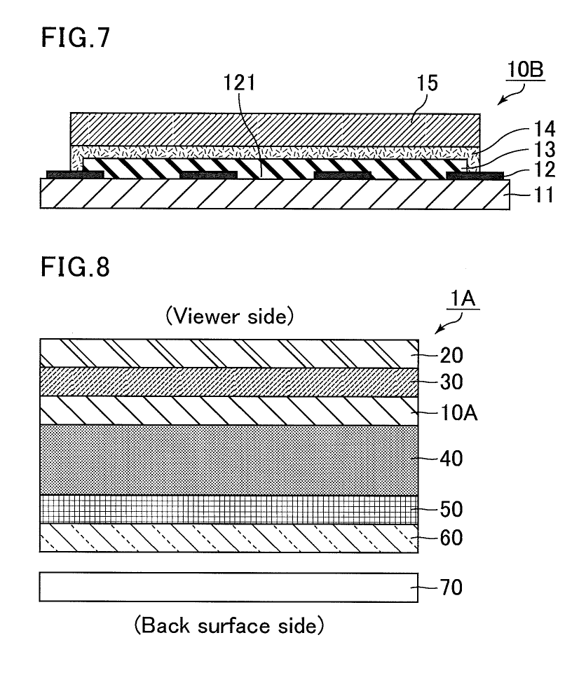

FIG. 7 is a schematic cross-sectional view of color filter substrate according to Example 3. In the color filter substrate 10B according to Example 2, the color filter substrate 10B according to Example 3 was produced in the same manner as in Example 2 except that the film thickness of the metal black matrix 12 was 0.2 μm.

### Comparative Example 1

FIG. 12 is a schematic cross-sectional view of color filter substrate according to Comparative Example 1. In Comparative Example 1, as illustrated in FIG. 12, a color filter substrate 10R was produced including a glass substrate 11R, a resin black matrix 12R disposed on the glass substrate 11R and provided with openings 121R, a color layer 13R covering the openings 121R and formed of coloring photosensitive resin, an overcoat layer 14R disposed on the color layer 13R, and an in-cell retardation layer 15R disposed on the overcoat layer 14. The color filter substrate 10R according to Comparative Example 1 was produced in the same manner as in Example 2 except that a resin matrix 12R having a film thickness of 1.2 μm was formed in place of the metal black matrix 12 by using a conventional black photosensitive resin material.

### Comparative Example 2

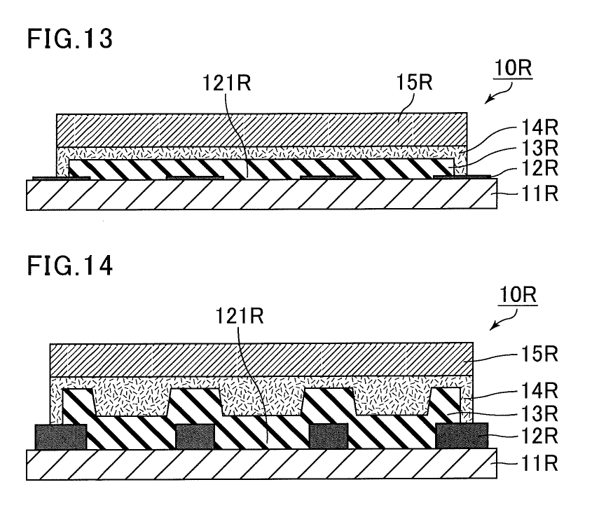

FIG. 13 is a schematic cross-sectional view of color filter substrate according to Comparative Example 2. The color filter substrate 10R according to Comparative Example 2 was produced in the same manner as in Comparative Example 1 except that the film thickness of the resin black matrix 12R was changed to 0.2 μm in the color filter substrate 10R according to Comparative Example 1.

### Comparative Example 3

FIG. 14 is a schematic cross-sectional view of color filter substrate according to Comparative Example 3. In the color filter substrate 10R according to Comparative Example 1, the color filter substrate 10R according to Comparative Example 3 was produced in the same manner as in Comparative Example 1 except that the film thickness of the overcoat layer 14R was changed to 3.0 μm.

### Evaluation of Examples 1 to 3 and Comparative Examples 1 to 3

For the color filter substrates according to Examples 1 to 3 and Comparative Examples 1 to 3, a step between a sub-pixel central part and the vicinity of a black matrix (the metal black matrix 12 or the resin black matrix 12R), light leakage from the opening of the black matrix, the OD value of the black matrix, and light leakage from the black matrix when the black matrix was sandwiched between a pair of polarizing plates disposed in crossed Nicols were evaluated by the following method.

### <Step Between Sub-Pixel Central Part and Black Matrix Layer Vicinity>

For the color filter substrates according to Examples 1 to 3 and Comparative Examples 1 to 3, the step between the sub-pixel central part and the vicinity of the black matrix was measured by a contact type profilometer before the in-cell retardation layer was applied (in a state in which the color layer was provided or a state in which an overcoat layer is provided).

<Light leakage from opening of black matrix when sandwiched between a pair of polarizing plates disposed in crossed Nicols>

After the in-cell retardation layer is applied, light leakage from the opening of the black matrix was checked with a microscope while the color filter substrate was sandwiched between a front circularly polarizing plate and a back linearly polarizing plate. The front circularly polarizing plate is a laminated body of a front linearly polarizing plate and a λ/4 plate (having an in-plane phase difference of 158 nm for a wavelength of 550 nm) in which the front linearly polarizing plate and the back linearly polarizing plate were disposed in crossed Nicols, and the λ/4 plate and the in-cell retardation layer were disposed so that their in-plane slow axes were orthogonal to each other. “Good” indicates a case in which no light leakage was checked, and “Poor” indicates a case in which light leakage was checked.

<OD value>

The optical density (OD value) of the black matrix was determined by using an ultraviolet visible near-infrared spectrophotometer V-7100 (manufactured by JASCO Corporation). The OD value was calculated by Equation 1 below.

OD=log₁₀(I/T) (1)

In Equation 1, I represents the light source intensity, and T represents the transmittance.

<Light Leakage from Black Matrix>

Since the OD value of the black matrix can be obtained by Equation 1 above, the OD value is three and the contrast of the black matrix is 1000, for example, when the light source intensity is 100% and the transmittance is 0.1%. It is thought that light leakage from the black matrix can be prevented when the contrast of the black matrix is equal to or higher than the contrast of liquid crystal panel. The contrast ratio of liquid crystal panel of the conventional FFS mode is approximately 1500:1 at the highest, and thus light leakage from the black matrix is prevented when the contrast ratio of the black matrix is equal to or higher than 1500:1. Specifically, it is thought that light leakage from the black matrix can be prevented when the OD value of the black matrix is equal to or higher than 3.2. Accordingly, in the evaluation of light leakage from the black matrix, “Good” indicates a case in which the OD value of the black matrix measured as described above was equal to or larger than 3.2, and “Poor” indicates a case in which the OD value was lower than 3.2.

Results are listed in Table 1 below.

TABLE 1

| | Color filter substrate | | | | | |
|---|---|---|---|---|---|---|
| | | | | Comparative | Comparative | Comparative |
| | Example 1 | Example 2 | Example 3 | Example 1 | Example 2 | Example 3 |
| Bblack matrix type | Metal | Metal | Metal | Resin | Resin | Resin |
| Black matrix film thickness (μm) | 0.1 | 0.1 | 0.2 | 1.2 | 0.2 | 1.2 |
| Overcoat layer film thickness (μm) | — | 1.3 | 1.3 | 1.3 | 1.3 | 3.0 |
| Step between sub-pixel central | 0.05 | 0.02 | 0.02 | 0.25 | 0.02 | 0.02 |
| part and black matrix vicinity (μm) | | | | | | |
| Light leakage from opening of black | Good | Good | Good | Poor | Good | Good |
| matrix when sandwiched between a | | | | | | |
| pair of polarizing plates disposed | | | | | | |
| in crossed Nicols | | | | | | |
| OD value | 4.1 | 4.1 | 5.8 | 4.6 | 1.0 | 4.6 |
| Light leakage from black matrix | Good | Good | Good | Good | Poor | Good |

Table 1 indicates that, in the color filter substrates according to Examples 1 and 2, the step between the sub-pixel central part and the vicinity of the black matrix was 0.05 μm or smaller. After the retardation layer was applied thereon, the light leakage was checked by a microscope while the color filter substrate was sandwiched between the front circularly polarizing plate and the back linearly polarizing plate. As a result, it is found that no light leakage occurs from the opening of the black matrix.

In the color filter substrate according to Comparative Example 1, the step between the sub-pixel central part and the vicinity of the black matrix was 0.25 μm. After the retardation layer 15R was applied on the overcoat layer 14R, a color filter substrate 1R was checked by a microscope similarly to Example 1. As a result, it is found that light leakage occurs from the opening of the black matrix.

In the color filter substrate according to Comparative Example 2, the step between the sub-pixel central part and the vicinity of the black matrix was 0.02 μm. After the retardation layer 15R was applied on the overcoat layer 14R, the color filter substrate 1R was checked by a microscope similarly to Example 1. As a result, it is found that no light leakage occurs from the opening of the black matrix, but found that light leakage occurs from the black matrix because the OD value of the black matrix was low.

### Example 4

FIG. 8 is a schematic cross-sectional view of a liquid crystal display device according to Example 4. In Example 4, the liquid crystal display device 1A of the FFS mode was produced by the following method by using the color filter substrate 10A produced in Example 1.

### <Liquid Crystal Cell Production>

On a glass substrate as a substrate, a drive TFT was disposed at each sub-pixel, and then a counter electrode formed in a solid pattern and made of IZO (In—Zn—O), an insulating film, and a pixel electrode made of IZO and having an opening in a stripe shape were sequentially disposed at the opening of the sub-pixel, thereby producing the active matrix substrate 50 for the FFS mode.

The photo-alignment film used in Example 1 was applied on the color filter substrate 10A and the active matrix substrate 50 according to Example 1 by a flexographic printing method, and preliminary firing, polarization UV irradiation, and main firing were performed. Subsequently, a light-curing sealing material to be hardened with UV light was drawn at an outer peripheral part of the color filter substrate 10A.

A FFS mode liquid crystal material having negative anisotropy of dielectric constant was dropped on the active matrix substrate 50 so that the retardation (Δnd) as a liquid crystal layer was 320 nm in the liquid crystal cell, and bonded to the color filter substrate 10A on which the light-curing sealing material was drawn. Thereafter, the sealing material was hardened through UV irradiation to produce the liquid crystal cell. In this case, the in-plane phase difference value of the retardation layer 15 was 140.8 nm for a wavelength of 550 nm.

### <Front Circularly Polarizing Plate (First Polarizing Plate 20 and Out-Cell Retardation Layer 30)>

The front circularly polarizing plate was produced by stacking a λ/4 plate (out-cell retardation layer 30) produced by uniaxially stretching a commercially available phase difference film (Zeonor film (manufactured by Zeon Corporation)) on a commercially available polarizing plate (CVT-1764FCUHC (manufactured by Nitto Denko Corporation)) as the first polarizing plate 20 with adhesive interposed therebetween. The stacking was performed so that the absorption axis of the first polarizing plate 20 was 0° and the slow axis of the λ/4 plate was 135° when the horizontal direction of a display screen was taken to be 0°. In this case, the in-plane phase difference value of the λ/4 plate was 141.0 nm for a wavelength of 550 nm.

### <Back Linearly Polarizing Plate (Second Polarizing Plate 60)>

A commercially available polarizing plate (CVT-1764FCUHC (manufactured by Nitto Denko Corporation)) was used as the back linearly polarizing plate. In this case, the absorption axis of the second polarizing plate 60 was 90° when the horizontal direction of the display screen was taken to be 0°.

### <Production of Liquid Crystal Display Device>

The front circularly polarizing plate and the back linearly polarizing plate were bonded to the liquid crystal cell through adhesive, and the backlight 70 was disposed on the back surface side of the back linearly polarizing plate, thereby producing the FFS mode liquid crystal display device 1A according to Example 4. Specifically, the liquid crystal display device 1A according to Example 4 includes, sequentially from the viewer side, the first polarizing plate 20, the out-cell retardation layer 30 having a phase difference of λ/4, the color filter substrate 10A, the liquid crystal layer 40, the active matrix substrate 50, the second polarizing plate 60, and the backlight 70.

### Example 5

An FFS mode liquid crystal display device according to Example 5 was produced in the same manner as in Example 4 except that the color filter substrate 10A according to Example 1 was changed to the color filter substrate 10B according to Example 2.

### Example 6

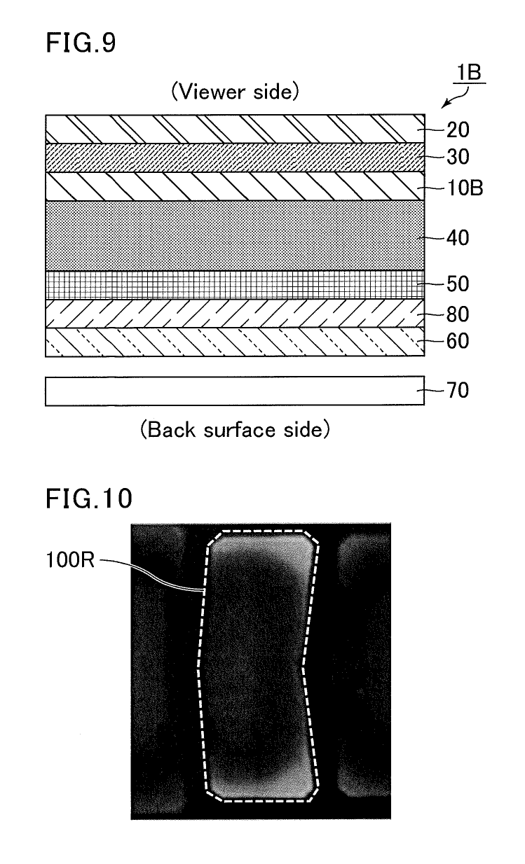

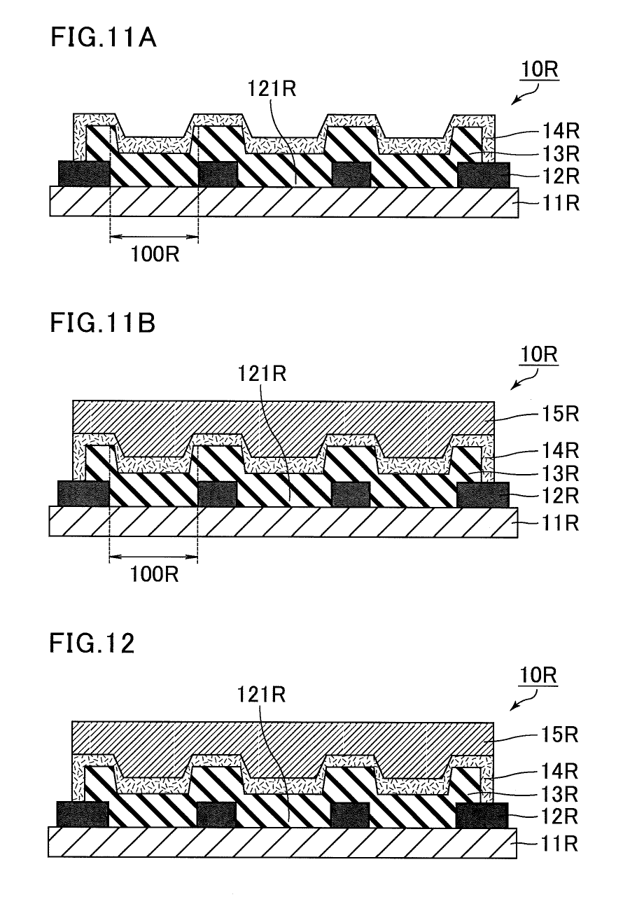

FIG. 9 is a schematic cross-sectional view of a liquid crystal display device according to Example 6. In Example 6, the VA mode liquid crystal display device 1B was produced by the following method by using the color filter substrate 10B produced in Example 2.

### <Production of Liquid Crystal Cell>

On a glass substrate as a substrate, a drive TFT was disposed at each sub-pixel, and then a pixel electrode made of ITO (In—Sn—O) was disposed at the opening of the sub-pixel, thereby producing the active matrix substrate 50 for the VA mode. In addition, a counter electrode made of ITO was formed on the color filter substrate 10B produced in Example 2.

Thereafter, a vertical alignment film that vertically aligns liquid crystal molecules was formed on each of the substrates 50 and 10B by a flexographic printing method, and preliminary firing, polarization UV irradiation, and main firing were performed. Subsequently, a light-curing sealing material to be hardened with UV light was drawn at an outer peripheral part of the liquid crystal cell at an outer peripheral part of the color filter substrate 10B.

A VA mode liquid crystal material having negative anisotropy of dielectric constant was dropped on the active matrix substrate 50 so that the retardation (And) as a liquid crystal layer was 330 nm in the liquid crystal cell, and the active matrix substrate 50 was bonded to the color filter substrate 10B on which the light-curing sealing material was drawn. Thereafter, the sealing material was hardened through UV irradiation to produce the liquid crystal cell.

### <Front Circularly Polarizing Plate (First Polarizing Plate 20 and Out-Cell Retardation Layer 30)>

The front circularly polarizing plate was produced by stacking a λ/4 plate (out-cell retardation layer 30) produced by uniaxially stretching a commercially available phase difference film (Zeonor film (manufactured by Zeon Corporation)) on a commercially available polarizing plate (CVT-1764FCUHC (manufactured by Nitto Denko Corporation)) as the first polarizing plate 20 with adhesive interposed therebetween. The stacking was performed so that the absorption axis of the first polarizing plate 20 was 0° and the slow axis of the λ/4 plate was 135° when the horizontal direction of a display screen was taken to be 0°. In this case, the in-plane phase difference value of the λ/4 plate was 140.6 nm for a wavelength of 550 nm.

### <Back Polarizing Plate (Second Polarizing Plate 60 and Viewing Angle Compensation Film 80)>

The viewing angle compensation film 80 (having an in-plane phase difference Re of 63.4 nm and a phase difference Rth of 241.7 nm in the thickness direction for a wavelength of 550 nm) was produced by biaxially stretching a commercially available phase difference film (Zeonor film (manufactured by Zeon Corporation)) and stacked on a commercially available polarizing plate (CVT-1764FCUHC (manufactured by Nitto Denko Corporation)) as the second polarizing plate 60 through adhesive, thereby producing a back polarizing plate. The stacking was performed so that the absorption axis of the second polarizing plate 60 was 90° and the slow axis of the viewing angle compensation film 80 was 0° when the horizontal direction of the display screen was taken to be 0°.

### <Production of Liquid Crystal Display Device>

The front circularly polarizing plate and the back polarizing plate were bonded to the liquid crystal cell through adhesive, and the backlight 70 was disposed on the back surface side of the back linearly polarizing plate, thereby producing the VA mode liquid crystal display device 1B according to Example 6. Specifically, the liquid crystal display device 1B according to Example 6 includes, sequentially from the viewer side, the first polarizing plate 20, the out-cell retardation layer 30 having a phase difference of λ/4, the color filter substrate 10B, the liquid crystal layer 40, the active matrix substrate 50, the viewing angle compensation film 80, the second polarizing plate 60, and the backlight 70.

### Comparative Example 4

An FFS mode liquid crystal display device according to Comparative Example 4 was produced in the same manner as in Example 4 except that the color filter substrate 10A according to Example 1 was changed to the color filter substrate 1R according to Comparative Example 1.

### Comparative Example 5

An FFS mode liquid crystal display device according to Comparative Example 5 was produced in the same manner as in Example 4 except that the color filter substrate 10A according to Example 1 was changed to the color filter substrate 10R according to Comparative Example 3.

### Comparative Example 6

A VA mode liquid crystal display device according to Comparative Example 6 was produced in the same manner as in Example 6 except that the color filter substrate 10B according to Example 2 was changed to the color filter substrate 10R according to Comparative Example 1.

### [Evaluation of Examples 4 to 6 and Comparative Examples 4 to 6]

The front contrast and the parallax color mixture were evaluated by the following method for the liquid crystal display devices according to Examples 4 to 6 and Comparative Examples 4 to 6. Results are listed in Tables 2 and 3.

### <Front Contrast>

For each of the liquid crystal display devices according to Examples 4 to 6 and Comparative Examples 4 to 6, the contrast in the front direction was measured by using a spectral radiance meter “SR-UL1 (manufactured by TOPCON)”.

### <Parallax Color Mixture>

The evaluation of the parallax color mixture was performed by the following method.

Five subjects were asked to obliquely (in a direction at the polar angle of 60°) observe three kinds of screens, that is, a screen on which only the red sub-pixels were turned on, a screen on which only the green sub-pixels were turned on, and a screen on which only the blue sub-pixels were turned on, comprehensively evaluate the parallax color mixture of each of the three kinds of screens, and evaluate the degree of color mixture in the order of A (good), B, C, and D (poor).

TABLE 2

| | FFS mode liquid crystal display device | | | |
|---|---|---|---|---|
| | | | Comparative | Comparative |
| | Example 4 | Example 5 | Example 4 | Example 5 |
| Color filter substrate | Example 1 | Example 2 | Comparative | Comparative |
| | | | Example 1 | Example 3 |
| Front contrast | 680 | 690 | 490 | 670 |
| Parallax color | A | A or B | A or B | D |
| mixture | | | | |

TABLE 3

VA mode liquid crystal
display device

| | Example 6 | Comparative Example 6 |
|---|---|---|
| Color filter substrate | Example 2 | Comparative Example 1 |
| Front contrast | 1320 | 1050 |
| Parallax color mixture | A or B | A |

In the liquid crystal display device according to Comparative Example 4, light leakage occurred due to a phase difference mismatch between the in-cell retardation layer and the out-cell retardation layer in a sub-pixel, and the front contrast was low. In the liquid crystal display devices according to Examples 4 and 5, no light leakage occurred in a sub-pixel (the opening of the black matrix), and the front contrast was high.

In the liquid crystal display devices according to Examples 5 and 6, in which the overcoat layer and the in-cell retardation layer were stacked, it was determined that the parallax color mixture was slightly observed but caused no problem. In the liquid crystal display device according to Comparative Example 5, the thickness of the overcoat layer provided for flattening was large at 3.0 μm, and the parallax color mixture was poor.

The color filter substrate according to Example 3 was same as the color filter substrate according to Example 2 except that the metal black matrix had a different film thickness. The step between the sub-pixel central part and the vicinity of the black matrix was same between Examples 2 and 3, and the OD value was sufficiently large in Examples 2 and 3. Thus, it is thought that results same as those of the liquid crystal display device according to Example 5 can be obtained when a FFS mode liquid crystal display device is produced by using the color filter substrate according to Example 3, and it is thought that results same as those of the liquid crystal display device according to Example 6 can be obtained when a VA mode liquid crystal display device is produced by using the color filter substrate according to Example 3.

What is claimed is:

1. A color filter substrate comprising:
a substrate;
a metal black matrix disposed on the substrate and provided with an opening;
a color layer covering the opening and made of coloring photosensitive resin; and
a retardation layer disposed on the color layer.

2. The color filter substrate according to claim 1, further comprising an overcoat layer between the color layer and the retardation layer.

3. The color filter substrate according to claim 1,
wherein the metal black matrix has a film thickness of 0.25 μm or smaller.

4. A liquid crystal display device comprising, sequentially from a viewer side:
a first polarizing plate;
a retardation layer having a phase difference of λ/4;
a color filter substrate;
a liquid crystal layer having anisotropy of dielectric constant;
an active matrix substrate including a switching element; and
a second polarizing plate,
wherein the color filter substrate includes a substrate, a metal black matrix disposed on the substrate and provided with an opening, a color layer covering the opening and made of coloring photosensitive resin, and a retardation layer disposed on the color layer.

5. The liquid crystal display device according to claim 4,
wherein the color filter substrate further includes an overcoat layer between the color layer and the retardation layer.

6. The liquid crystal display device according to claim 4,
wherein the metal black matrix has a film thickness of 0.25 μm or smaller.

7. The liquid crystal display device according to claim 4,
wherein the retardation layer included in the color filter substrate has a phase difference of λ/4.

8. The liquid crystal display device according to claim 4,
wherein a display mode is an IPS mode, an FFS mode, or a VA mode.
